(19) United States
(12) Patent Application Publication
(10) Pub. No.: US 2022/0095771 A1
(43) Pub. Date: Mar. 31, 2022

(54) INTELLIGENT PROTECTIVE PACK

(71) Applicant: Zeon Quan Technology Co., Ltd., Kaohsiung City (TW)

(72) Inventor: HSING HSUN LEE, Kaohsiung City (TW)

(21) Appl. No.: 17/088,715

(22) Filed: Nov. 4, 2020

(30) Foreign Application Priority Data
Sep. 29, 2020 (TW) 109133924

(51) Int. Cl. A45F 3/02; G08B 25/01; F41H 5/08

(52) U.S. Cl. CPC A45F 3/02; A45F 2003/003; F41H 5/08; G08B 25/016

(57) ABSTRACT

An intelligent protective pack includes: a protective bag body having a front surface and a back surface, wherein the front surface is provided with a pressure signal impact region, and the back surface is provided with a first grip and a second grip; and a distress signal transmitting unit including a first pressure sensor, a second pressure sensor and a third pressure sensor, wherein the first pressure sensor and the second pressure sensor are respectively disposed in the first grip and the second grip, and the third pressure sensor is disposed in the pressure signal impact region. The intelligent protective pack has a backpack function, a body protection function, and a function of sending out an emergency call for help.

### CROSS-REFERENCE TO RELATED APPLICATION

This application claims the benefit of Taiwan Patent Application No. 109133924, filed on Sep. 29, 2020, which is hereby incorporated by reference for all purposes as if fully set forth herein.

### BACKGROUND

### Technical Field

The present disclosure relates to an intelligent protective pack, and in particular, to an intelligent protective pack having a backpack function, a body protection function, and a function of sending out an emergency call for help.

### Related Art

A backpack is mainly used for holding items, and is portable and widely used in social life. With continuous development of times and changes of social conditions, people not only require the backpack to carry items, and but also have higher functional requirements on the backpack.

A conventional bullet-proof travel bag has a protective bag body. The protective bag body includes an anti-abrasive layer located outside the protective bag body. The anti-abrasive layer is provided with a sandwich layer, a bullet-proof layer is disposed inside the sandwich layer, and the bullet-proof layer is made of a soft material. A conventional multifunctional wild backpack also has a protective bag body. To also have a bullet-proof function, a bullet-proof layer and a foam board are sequentially fixed from the outside to the inside of the protective bag body. Obviously, the two types of protective bag bodies with different structures both have a certain bullet-proof function, and may be used as a personal protective device to ensure life safety to some extent.

TW Patent NO. M332827 discloses a bullet-proof backpack 9 mainly including a protective bag body having at least one sandwich layer, and at least one armor. The protective bag body has an accommodation space for placing items. The armor is inserted in the sandwich layer to effectively block a bullet, and is convenient to install and replace. Therefore, good safety protection is provided for a user 2 in duty or in an emergency, as shown in FIG. 1. However, when the foregoing bullet-proof backpack is attacked, there is no design for transmitting a distress signal.

Therefore, an intelligent protective pack is needed to solve the foregoing problem.

### SUMMARY

An objective of the present disclosure is to provide an intelligent protective pack having a backpack function, a body protection function, and a function of sending out an emergency call for help.

Another objective of the present disclosure is to provide an intelligent protective pack capable of reducing bacteria breeding on a first protective bag body and a second protective bag body because of perspiration of a body of a user.

According to the foregoing objectives, the present disclosure provides an intelligent protective pack, including: a protective bag body having a front surface and a back surface, wherein the front surface is provided with a pressure signal impact region, and the back surface is provided with a first grip and a second grip; and a distress signal transmitting unit, including a first pressure sensor, a second pressure sensor and a third pressure sensor, wherein the first pressure sensor and the second pressure sensor are respectively disposed in the first grip and the second grip, and the third pressure sensor is disposed in the pressure signal impact region.

The present disclosure further provides an intelligent protective pack, including: a protective bag body, an anti-cutting material layer, a bullet-proof material layer and an anti-microbial material layer arranged sequentially, and having a front surface and a back surface, wherein the front surface is provided with a pressure signal impact region, the back surface is provided with a first grip, a second grip and an elastic band, and the elastic band is disposed between the first grip and the second grip; and a distress signal transmitting unit, including a first pressure sensor, a second pressure sensor and a third pressure sensor, wherein the first pressure sensor and the second pressure sensor are respectively disposed in the first grip and the second grip, and the third pressure sensor is disposed in the pressure signal impact region.

Features of the intelligent protective pack in the present disclosure are as follows: the intelligent protective pack in the present disclosure has a backpack function, a body protection function, and a function of sending out an emergency call for help. Moreover, the anti-microbial material layer of the intelligent protective pack is disposed close to the body of the user, so that bacteria breeding on the protective bag body caused by perspiration of the body of the user can be reduced, thereby reducing stink of a conventional protective bag caused by the perspiration of the body of the user.

### BRIEF DESCRIPTION OF THE DRAWINGS

FIG. 1 is a three-dimensional schematic diagram of a bullet-proof pack in use in the prior art.

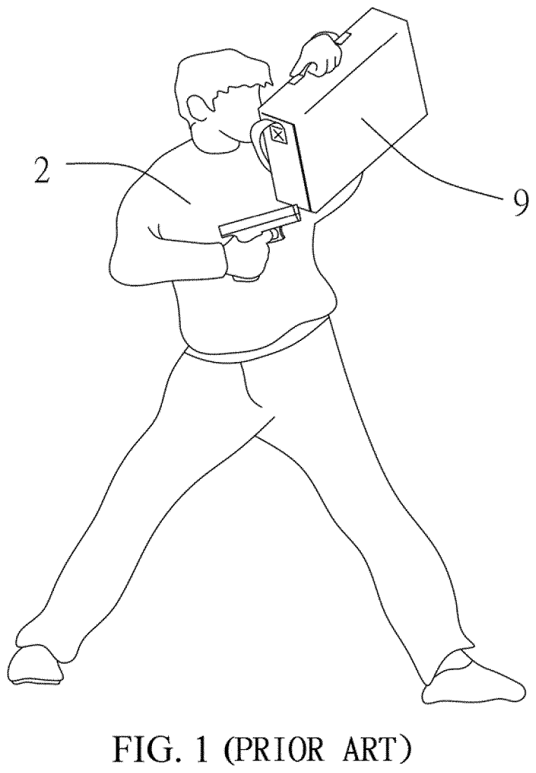

FIG. 2 is a three-dimensional schematic diagram of an intelligent protective pack according to an embodiment of the present disclosure, showing a front surface of the intelligent protective pack.

FIG. 3 is a three-dimensional schematic diagram of an intelligent protective pack according to an embodiment of the present disclosure, showing a back surface of the intelligent protective pack.

FIG. 4 is a three-dimensional schematic diagram of an intelligent protective pack in use according to an embodiment of the present disclosure, showing that the intelligent protective pack is gripped by one hand.

FIG. 5 is a schematic block diagram of a circuit of a distress signal transmitting unit of an intelligent protective pack according to an embodiment of the present disclosure.

FIG. 6a and FIG. 6b are three-dimensional schematic diagrams of an intelligent protective pack in use according to two embodiments of the present disclosure, showing that the intelligent protective pack is gripped by both hands.

FIG. 7a is a schematic cross-sectional diagram of a protective bag body of an intelligent protective pack according to an embodiment of the present disclosure.

FIG. 7b is a schematic cross-sectional diagram of a protective bag body of an intelligent protective pack according to another embodiment of the present disclosure.

### DETAILED DESCRIPTION

To make the foregoing objectives, characteristics and features of the present disclosure more comprehensible, preferred embodiments of the present disclosure are described in detail below with reference to the accompanying drawings.

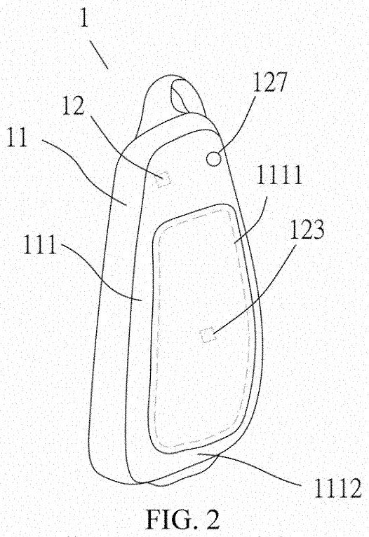

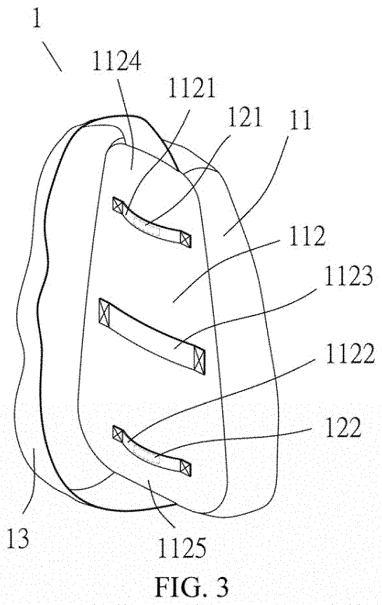

FIG. 2 is a three-dimensional schematic diagram of an intelligent protective pack according to an embodiment of the present disclosure, showing a front surface of the intelligent protective pack. FIG. 3 is a three-dimensional schematic diagram of an intelligent protective pack according to an embodiment of the present disclosure, showing a back surface of the intelligent protective pack. Referring to FIG. 2 and FIG. 3, the intelligent protective pack 1 includes: a protective bag body 11 and a distress signal transmitting unit 12. The protective bag body 11 has a front surface 111 and a back surface 112. The front surface 111 is provided with a pressure signal impact region 1111. The back surface 112 is provided with a first grip 1121, a second grip 1122 and an elastic band 1123. The elastic band 1123 is located between the first grip 1121 and the second grip 1122. In this embodiment, the pressure signal impact region 1111 has a predetermined area. The ratio of the predetermined area to an area of the front surface 111 of the protective bag body 11 can be in a range of 1:3 to 1:2. The pressure signal impact region 1111 is located near a side 1112 of the front surface 111. The first grip 1121 and the second grip 1122 are located near both sides 1124 and 1125 of the back surface 112.

Referring to FIG. 2 and FIG. 3, the intelligent protective pack 1 can have a backpack function. For example, the intelligent protective pack 1 can be a single shoulder backpack (e.g., a shoulder strip 13 shown in FIG. 3 can be used on the shoulder), a backpack with double shoulder strips, a handbag or other bags for holding items.

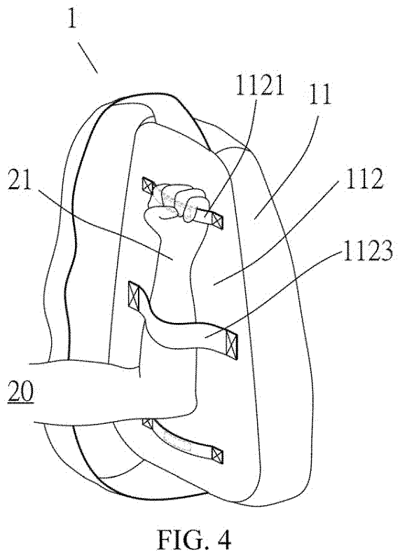

FIG. 4 is a three-dimensional schematic diagram of an intelligent protective pack in use according to an embodiment of the present disclosure, and showing the intelligent protective pack is gripped by one hand. Referring to FIG. 4, the intelligent protective pack 1 has a function of protecting a body 20. For example, when being attacked, a user can pass one hand (either a left hand 21 or a right hand 22) through the elastic band 1123 on the back surface 112 of the intelligent protective pack 1, and then grasp the first grip 1121. In this way, the intelligent protective pack 1 has an effect of protecting the body 20 immediately.

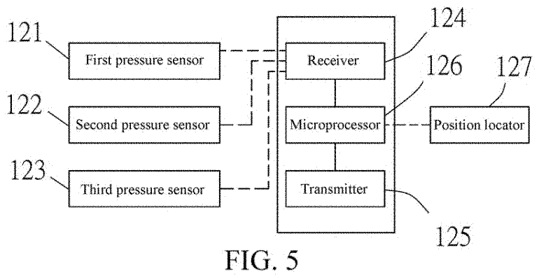

Specially, the intelligent protective pack 1 further has a function of sending out an emergency call for help. FIG. 5 is a schematic block diagram of a circuit of a distress signal transmitting unit of an intelligent protective pack according to an embodiment of the present disclosure. Referring to FIG. 5, FIG. 2 and FIG. 3, the distress signal transmitting unit 12 includes a first pressure sensor 121, a second pressure sensor 122 and a third pressure sensor 123. The first pressure sensor 121 and the second pressure sensor 122 are respectively disposed in the first grip 1121 and the second grip 1122, and the third pressure sensor 123 is disposed in the pressure signal impact region 1111. In addition to the first pressure sensor 121, the second pressure sensor 122 and the third pressure sensor 123, the distress signal transmitting unit 12 further includes: a receiver 124, a transmitter 125, and a microprocessor 126. The receiver 124 (e.g., a receiving antenna) is electrically connected to the first pressure sensor 121, the second pressure sensor 122 and the third pressure sensor 123, and is used for receiving pressure signals from the first pressure sensor 121, the second pressure sensor 122 and the third pressure sensor 123. The transmitter 125 (e.g., a transmitting antenna) is used for transmitting a distress signal. The microprocessor 126 is electrically connected to the receiver 124 and the transmitter 125, and is used for determining whether to transmit the distress signal according to the pressure signals from the first pressure sensor 121, the second pressure sensor 122 and the third pressure sensor 123. The receiver 124, the transmitter 125 and the microprocessor 126 can be all disposed on the front surface 111 of the protective bag body 11. The receiver 124 is electrically connected to the first pressure sensor 121, the second pressure sensor 122 and the third pressure sensor 123 in a manner of wireless communication or wire communication. The first pressure sensor 121, the second pressure sensor 122 and the third pressure sensor 123 can be a strain gauge sensor, a variable capacitance sensor or a piezoelectric sensor.

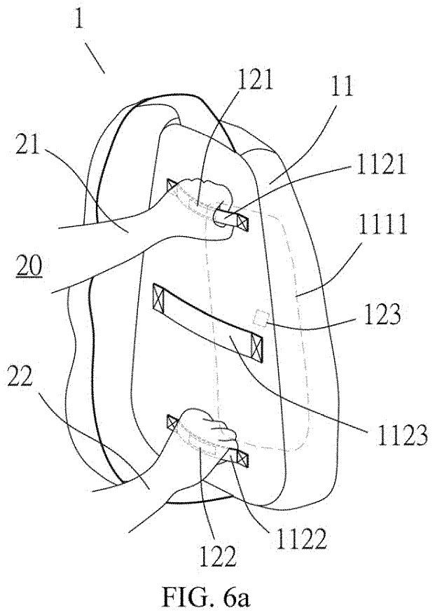

FIG. 6a and FIG. 6b are three-dimensional schematic diagrams of an intelligent protective pack in use according to two embodiments of the present disclosure, showing that the intelligent protective pack is gripped by both hands. Referring to FIG. 6a, when the user is attacked, the user can hold the first grip 1121 and the second grip 1122 with both hands (that is, the left hand 21 and the right hand 22), to protect the body 20 with the intelligent protective pack 1, and at the same time press the first pressure sensor 121 and the second pressure sensor 122 transmit pressure signals. Alternatively, referring to FIG. 6b, when the user is attacked, the user can first pass one hand (e.g., the left hand 21) through the elastic band 1123 on the back surface 112 of the intelligent protective pack 1 to grasp the first grip 1121, and then grasp the second grip 1122 with another hand (e.g., the right hand 22), to protect the body 20 with the intelligent protective pack 1, and at the same time press the first pressure sensor 121 and the second pressure sensor 122 to transmit pressure signals.

Referring to FIG. 5, in this case, the receiver 124 can receive the pressure signals from the first pressure sensor 121 and the second pressure sensor 122, and transfer the pressure signals to the microprocessor 126. After the microprocessor 126 receives the pressure signals from the first pressure sensor 121 and the second pressure sensor 122, the microprocessor 126 can start to detect whether a pressure signal from the third pressure sensor 123 is also received, and detect whether the pressure signal from the third pressure sensor 123 is greater than a preset value (e.g., 30 Kgw/cm²). If the pressure signal impact region 1111 is shot or stabbed, the pressure signal from the third pressure sensor 123 is greater than the preset value, and in this case, the microprocessor 126 can transmit the distress signal through the transmitter 125. For example, the distress signal can be transmitted to a nearby police station, so that the police arrive at a site of accident as quickly as possible.

Referring to FIG. 2 and FIG. 5, the intelligent protective pack 1 further includes: a position locator 127, disposed on the front surface 111 of the protective bag body 11, and used for providing a positioned location of the intelligent protective pack 1. The position locator 127 can be electrically connected to the microprocessor 126. The position locator can be a Global Positioning System (GPS) position locator 127. The position locator 127 can be used alone, if the intelligent protective pack 1 is missing or stolen, the intelligent protective pack 1 can be found as soon as possible through the positioned location provided by the position locator 127. In addition, the position locator 127 can be used with reference to the distress signal transmitting unit 12. If the microprocessor 126 transmits the distress signal through the transmitter 125, the location provided by the position locator 127 can be sent together with the distress signal.

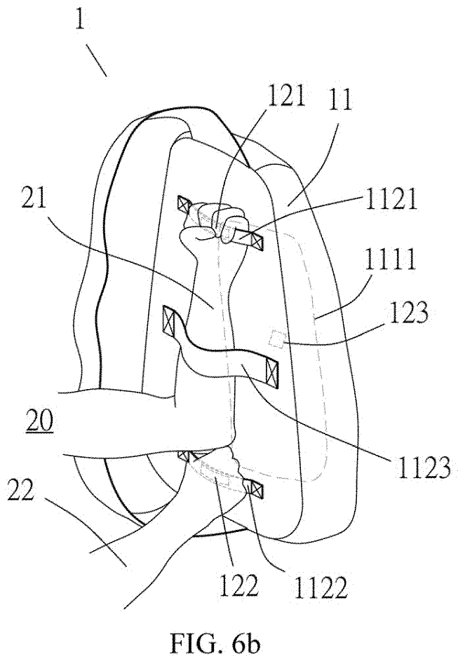

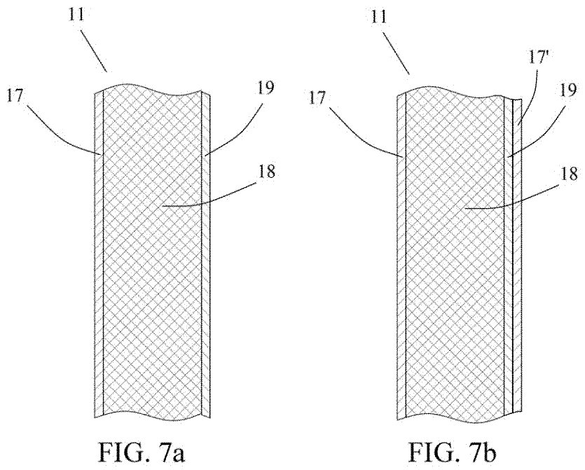

FIG. 7a is a schematic cross-sectional diagram of a protective bag body of an intelligent protective pack according to an embodiment of the present disclosure. Referring to FIG. 7a and FIG. 4, the protective bag body 11 includes an anti-cutting material layer 17, a bullet-proof material layer 18 and an anti-microbial material layer 19 arranged sequentially, and the anti-microbial material layer 19 is disposed close to a side of the body 20 of the user. In this embodiment, the anti-cutting material layer 17, the bulletproof material layer 18 and the antimicrobial material layer 19 are sequentially stacked. The anti-cutting material 17 is an anti-cutting cloth, the bulletproof material 18 is ultra-high molecular weight polyethylene fiber (UHMWPE), and the anti-microbial material layer 19 is copper fiber. The anti-microbial material layer 19 is disposed close to the body 20 of the user, so that bacteria breeding on the protective bag body 11 caused by perspiration of the body 20 of the user can be reduced, thereby reducing stink of a conventional protective bag caused by the perspiration of the body of the user.

FIG. 7b is a schematic cross-sectional diagram of a protective bag body of an intelligent protective pack according to another embodiment of the present disclosure. Referring to FIG. 7b and FIG. 4, the protective bag body 11 further includes another anti-cutting material layer 17′ used for covering the anti-microbial material layer 19. The another anti-cutting material layer 17′ is also an anti-cutting cloth, so that outermost layers of the front surface 111 and the back surface 112 of the protective bag body 11 are both the anti-cutting cloth, and the protective bag body 11 has an integrated appearance.

Features of the intelligent protective pack in the present disclosure are as follows: the intelligent protective pack in the present disclosure has a backpack function, a body protection function, and a function of sending out an emergency call for help. Moreover, the antimicrobial material layer of the intelligent protective pack is disposed close to the body of the user, so that bacteria breeding on the protective bag body caused by perspiration of the body of the user can be reduced, thereby reducing stink of a conventional protective bag caused by the perspiration of the body of the user.

In view of the above, the foregoing descriptions are merely preferred embodiments of technical means adopted by the present disclosure to solve the problem, but are not intended to limit the scope of the embodiments of the present disclosure. Any equivalent variation and modification consistent with the meaning of the scope of the present disclosure or made according to the scope of the present disclosure shall fall within the protection scope of the present disclosure.

What is claimed is:

1. An intelligent protective pack, comprising:
a protective bag body having a front surface and a back surface, wherein the front surface is provided with a pressure signal impact region, and the back surface is provided with a first grip and a second grip; and
a distress signal transmitting unit, comprising a first pressure sensor, a second pressure sensor and a third pressure sensor, wherein the first pressure sensor and the second pressure sensor are respectively disposed in the first grip and the second grip, and the third pressure sensor is disposed in the pressure signal impact region.

2. The intelligent protective pack according to claim 1, wherein the distress signal transmitting unit further comprises: a receiver electrically connected to the first pressure sensor, the second pressure sensor and the third pressure sensor and used for receiving pressure signals from the first pressure sensor, the second pressure sensor and the third pressure sensor; a transmitter used for transmitting a distress signal; and a microprocessor electrically connected to the receiver and the transmitter, and used for determining whether to transmit the distress signal according to the pressure signals from the first pressure sensor, the second pressure sensor and the third pressure sensor.

3. The intelligent protective pack according to claim 2, wherein the receiver is electrically connected to the first pressure sensor, the second pressure sensor and the third pressure sensor in a manner of wireless communication or wire communication.

4. The intelligent protective pack according to claim 1, further comprising: a position locator disposed on the front surface of the protective bag body.

5. The intelligent protective pack according to claim 4, wherein the position locator is electrically connected to the microprocessor.

6. The intelligent protective pack according to claim 4, wherein the position locator is a Global Positioning System (GPS) position locator.

7. The intelligent protective pack according to claim 1, wherein the protective bag body comprises an anti-cutting material layer, a bullet-proof material layer and an anti-microbial material layer arranged sequentially.

8. An intelligent protective pack, comprising:
a protective bag body, comprising an anti-cutting material layer, a bulletproof material layer and an antimicrobial material layer arranged sequentially, and having a front surface and a back surface, wherein the front surface is provided with a pressure signal impact region, the back surface is provided with a first grip, a second grip and an elastic band, and the elastic band is located between the first grip and the second grip; and
a distress signal transmitting unit, comprising a first pressure sensor, a second pressure sensor and a third pressure sensor, wherein the first pressure sensor and the second pressure sensor are respectively disposed in the first grip and the second grip, and the third pressure sensor is disposed in the pressure signal impact region.

9. The intelligent protective pack according to claim 8, wherein the protective bag body further comprises another anti-cutting material layer used for covering the antimicrobial material layer.

10. The intelligent protective pack according to claim 9, wherein the anti-cutting material is an anti-cutting cloth, the bulletproof material is ultra-high molecular weight polyethylene fiber, and the antimicrobial material layer is copper fiber.
